(19) United States
(12) Patent Application Publication
(10) Pub. No.: US 2001/0007852 A1
(43) Pub. Date: Jul. 12, 2001

(54) Bleaching detergent compositions

(76) Inventors: Willem Antheunisse, Vlaardingen (NL); Cornelis Paul Van Der Logt, Vlaardingen (NL); Neil James Parry, Sharnbrook (GB); Ton Swarthoff, Vlaardingen (NL)

Correspondence Address: UNILEVER, PATENT DEPARTMENT, 45 RIVER ROAD, EDGEWATER, NJ, 07020, US

(21) Appl. No.: 09/742,692

(22) Filed: Dec. 20, 2000

(30) Foreign Application Priority Data
Dec. 23, 1999 (EP) 99310551.9

(51) Int. Cl. C12S 9/00; C11D 7/42; C11D 9/42; C11D 7/54; C11D 7/18; C11D 3/00; D06L 1/00

(52) U.S. Cl. 510/305; 510/374; 510/392

(57) ABSTRACT

There is provided an enzymatic bleaching detergent composition comprising a bleaching enzyme capable of generating a bleaching chemical and having a high binding affinity for stains present on fabrics, said enzyme comprising an enzyme part capable of generating a bleaching chemical which is coupled to a reagent having a high binding affinity for stains present on fabrics, characterised in that the pI of the reagent having the high binding affinity has a pI which is lower than the pH of an aqueous wash solution comprising 1 g/l of the composition.

### TECHNICAL FIELD

The present invention generally relates to bleaching detergent compositions. More in particular, it relates to enzymatic detergent compositions comprising bleaching enzymes which are targeted to stains present on fabrics.

### BACKGROUND AND PRIOR ART

Detergent compositions comprising bleaching enzymes have been described in the prior art. For instance, GB-A-2 101 167 (Unilever) discloses an enzymatic bleach composition in the form of a hydrogen peroxide-generating system comprising a C₁-C₄ alkanol oxidase and a C₁-C₄ alkanol. Such enzymatic bleach compositions may be used in detergent compositions for fabric washing, in which they may provide a low-temperature enzymatic bleach system. In the wash liquor, the alkanol oxidase enzyme catalyses the reaction between dissolved molecular oxygen and the alkanol to form an aldehyde and hydrogen peroxide. In order to obtain a significant bleach effect at low wash temperatures, e.g. at 15-55°C., the hydrogen peroxide must be activated by means of a bleach activator. Today, the most commonly used bleach activator is tetra-acetyl ethylene diamine (TAED), which yields peracetic acid upon reacting with the hydrogen peroxide, the peracetic acid being the actual bleaching agent.

WO-A-98/56885 (Unilever, incorporated herein by reference) discloses a bleaching enzyme which is capable of generating a bleaching chemical and having a high binding affinity for stains present on fabrics, as well as an enzymatic bleaching composition comprising said bleaching enzyme, and a process for bleaching stains on fabrics. The binding affinity may be formed by a part of the polypeptide chain of the bleaching enzyme, or the enzyme may comprise an enzyme part which is capable of generating a bleach chemical that is coupled to a reagent having the high binding affinity for stains present on fabrics. In the latter case the reagent may be bispecific, comprising one specificity for stain and one for enzyme. Examples of such bispecific reagents mentioned in the disclosure are antibodies, especially those derived from Camelidae having only a variable region of the heavy chain polypeptide (VHH), peptides, peptidomimics, and other organic molecules. The enzyme which is covalently bound to one functional site of the antibody usually is an oxidase, such as glucose oxidase, galactose oxidase and alcohol oxidase, which is capable of forming hydrogen peroxide or another bleaching agent. Thus, if the multi-specific reagent is an antibody, the enzyme forms an enzyme/antibody conjugate which constitutes one ingredient of a detergent composition. During washing, said enzyme/antibody conjugate of the detergent composition is targeted to stains on the clothes by another functional site of the antibody, while the conjugated enzyme catalyses the formation of a bleaching agent in the proximity of the stain and the stain will be subjected to bleaching.

Although this and several other enzymatic bleach systems have been proposed, there is still a need for alternative or improved enzymatic bleach systems. In particular, the enzymatic bleach system should be capable of bleaching stains which are otherwise difficult to remove, the so-called “problem stains” such as tea, blackberry juice, or red wine. Such stains would require a significant amount of bleaching for their removal, which might negatively affect the colours of the garment.

In conventional laundry bleach systems, fabrics are uniformly exposed to the same concentration of bleach, whether “problem stains” are present or not. Moreover, damage to garments (such as the fading of dyes) can be caused by repeated washing with conventional bleach systems, which may contain relatively high concentrations of bleach.

It is therefore an object of the present invention to provide alternative or improved enzymatic bleach systems which, in particular, should be capable of bleaching stains which are otherwise difficult to remove, and should preferably be more selective in its bleaching action. It is a further object of the present invention to provide an alternative or improved enzymatic bleach process.

We have now surprisingly found that it is possible to control the enzymatic bleaching reaction by means of the pI of the part having a high binding affinity for stains present on fabrics. It was found that the pI of the reagent having the high binding affinity should have a pI which is lower than the pH of an aqueous wash solution comprising 1 g/l of the composition.

The detergent compositions of the invention are particularly attractive for treating “problem stains” which occur only occasionally, such as tea, red-wine, and blackberry juice. These stains are not present on most garments and when they are present they are likely to be present in different positions than habitual stains such as those found on collars and cuffs. According to the invention, it is possible to optimise the in-use concentration of the new bleaching enzyme so that threshold concentrations of bleach are only reached if stain is present and the new bleaching enzyme binds to and accumulates on said stain. When this happens, the high local concentration of enzyme generates a high local concentration of bleach near to the stain and thereby exerts a selective bleaching action where it is required. Therefore, the unstained part of the garment (typically the majority) is not exposed to high levels of bleach and thereby this fabric is protected from bleach-associated damage. Moreover, the next time the same garment has a stain such as blackberry, tea, wine, etc. it is likely to be in a different position on the garment. Therefore, a different position on the garment will be exposed to high levels of bleach. Therefore, problems associated with several washes in conventional bleaching systems, such as dye-fade, will be reduced or eliminated altogether. This is in stark contrast to conventional bleaching systems where all garments are uniformly exposed to high concentrations of bleach, in every wash, regardless of whether problem stains are present or not.

### DEFINITION OF THE INVENTION

According to a first aspect of the invention, there is provided an enzymatic bleaching detergent composition comprising a bleaching enzyme capable of generating a bleaching chemical and having a high binding affinity for stains present on fabrics, said enzyme comprising an enzyme part capable of generating a bleaching chemical which is coupled to a reagent having a high binding affinity for stains present on fabrics, characterised in that the pI of the reagent having the high binding affinity has a pI which is lower than the pH of an aqueous wash solution comprising 1 g/l of the composition. Preferably, the pI is from 0.1-5, preferably from 0.1-2, more preferably from 0.2-0.5 units lower than the pH.

According to a second aspect, there is provided a process for bleaching stains present on fabrics using the enzymatic bleaching composition of the invention.

### BRIEF DESCRIPTION OF THE DRAWINGS

FIG. 1 shows the non-specific binding of a bihead having a pI value of 9.0 to unstained material;

FIG. 2 shows the non-specific binding of bihead 1249 having a pI value of 9.5 to unstained material;

FIG. 3 shows the non-specific binding of bihead 1249-myc, having a pI value of 8.8 to unstained material;

FIG. 4 shows the non-specific binding of bihead 1211 having a pI value of 8.0 to unstained material;

FIG. 5 shows the bleaching of a detergent composition above and below the pI of the bihead.

### DESCRIPTION OF THE INVENTION

1. The bleaching enzyme

In its first aspect, the invention relates to a bleaching enzyme which is capable of generating a bleaching chemical and comprises an enzyme part capable of generating a bleaching chemical which is coupled to a reagent having a high binding affinity for stains present on fabrics.

1.1 The enzyme part, capable of generating a bleaching chemical.

The bleaching chemical may be enzymatically generated hydrogen peroxide. The enzyme for generating the bleaching chemical or enzymatic hydrogen peroxide-generating system may in principle be chosen from the various enzymatic hydrogen peroxide-generating systems which have been disclosed in the art. For example, one may use an amine oxidase and an amine, an amino acid oxidase and an amino acid, cholesterol oxidase and cholesterol, uric acid oxidase and uric acid or a xanthine oxidase with xanthine. Alternatively, a combination of a C₁-C₄ alkanol oxidase and a C₁-C₄ alkanol is used, and especially preferred is the combination of methanol oxidase and ethanol. The methanol oxidase is preferably isolated from a catalase-negative Hansenula polymorpha strain. (see for example EP-A-244 920 (Unilever)). The preferred oxidases are glucose oxidase, galactose oxidase and alcohol oxidase.

A hydrogen peroxide generating enzyme could be used in combination with activators which generate peracetic acid. Such activators are well-known in the art. Examples include tetraacetylethylenediamine (TAED) and sodium nonanoyl-oxybenzenesulphonate (SNOBS). These and other related compounds are described in fuller detail by Grime and Clauss in Chemistry & Industry (Oct. 15, 1990) 647-653. Alternatively, a transition metal catalyst could be used in combination with a hydrogen peroxide generating enzyme to increase the bleaching power. Examples of manganese catalysts are described by Hage et al. (1994) Nature 369, 637-639.

Alternatively, the bleaching chemical is hypohalite and the enzyme part is then a haloperoxidase. Preferred haloperoxidases are chloroperoxidases and the corresponding bleaching chemical is hypochlorite. Especially preferred chloroperoxidases are Vanadium chloroperoxidases, for example from Curvularia inaequalis.

Alternatively, peroxidases or laccases may be used. In this case the bleaching molecule is derived from an enhancer molecule that has reacted with the enzyme. Examples of laccase/enhancer systems are given in WO-A-95/01426. Examples of peroxidase/enhancer systems are given in WO-A-97/11217.

1.2 The part having the high binding affinity.

The new bleaching enzyme has a high binding affinity for stains present on fabrics. It may be that one part of the polypeptide chain of the bleaching enzyme is responsible for the binding affinity, but it is also possible that the enzyme comprises an enzyme part capable of generating a bleaching chemical which is coupled to a reagent having the high binding affinity for stains present on fabrics. In the first situation, the bleaching enzyme may be a fusion protein comprising two domains which may be coupled by means of a linker. In the second situation, the reagent having the high binding affinity may be covalently coupled to the enzyme part for generating the bleaching chemical, by means of a bi-valent coupling agent such as glutardialdehyde. A full review of chemistries appropriate for coupling two biomolecules is provided in “Bioconjugate techniques” by Greg T. Hermanson, Academic Press Inc (1986). Alternatively, if the reagent having the high binding affinity is a peptide or a protein, it may also be coupled to the enzyme by constructing a fusion protein. In such a construct there would typically be a peptide linker between the binding reagent and the enzyme. An example of a fusion of an enzyme and a binding reagent is described in Ducancel et al. Bio/technology 11, 601-605.

A further embodiment would be for the reagent with a high binding affinity to be a bispecific reagent, comprising one specificity for stain and one for enzyme. Such a reagent could fulfil the requirement of accumulating enzyme on stain either by supplying said reagent together with enzyme as a pre-formed non-covalent complex or by supplying the two separately and allowing them to self-assemble either in the wash liquor or on the stain.

It is essential that the pI of the reagent having the high binding affinity has a pI which is lower than the pH of an aqueous wash solution comprising 1 g/l of the composition. Preferably, the pI is 0.1-5, 0.1-2 units lower than the pH, more preferably 0.2-0.5 units lower than the pH.

The skilled man can calculate the pI of the reagent having the high binding affinity and using modern recombinant DNA techniques he can subsequently prepare the modified reagents without difficulty.

The novel bleaching enzyme according to the invention is based on the presence of a part having a high binding affinity for stains present on fabrics.

The degree of binding of a compound A to another molecule B can be generally expressed by the chemical equilibrium constant K_{d} resulting from the following reaction:

[A]+[B] [symbol] [A=B]

The chemical equilibrium constant K_{d} is then given by:

$${K}_{d} = \frac{[ A ] \times [ B ]}{[ A ≡ B ]}$$

Whether the binding to the stains is specific or not can be judged from the difference between the binding (K_{d} value) of the compound to stained (i.e. a material treated so that stain components are bound on), versus the binding to unstained (i.e. untreated) material, or versus the binding to material stained with an unrelated chromophore. For applications in laundry, said material will be a fabric such as cotton or polyester. However, it will usually be more convenient to measure K_{d} values and differences in K_{d} values on other materials such as a polystyrene microtitre plate or a specialised surface in an analytical biosensor. The difference between the two binding constants should be minimally 10, preferably more than 100, and more preferably, more that 1000. Typically, the compound should bind the stain, or the stained material, with a K_{d} lower than 10⁻⁴ M, preferably lower than 10⁻⁶ M and could be 10⁻¹⁰ M or even less. Higher binding affinities (K_{d} of less than 10⁻⁵ M) and/or a larger difference between coloured substance and background binding would increase the selectivity of the bleaching process. Also, the weight efficiency of the compound in the total detergent composition would be increased and smaller amounts of the compound would be required.

Several classes of compounds can be envisaged which deliver the capability of specific binding to stains one would like to bleach. In the following we will give a number of examples of such compounds having such capabilities, without pretending to be exhaustive.

1.2.1. Antibodies.

Antibodies are well known examples of compounds which are capable of binding specifically to compounds against which they were raised. Antibodies can be derived from several sources. From mice, monoclonal antibodies can be obtained which possess very high binding affinities. From such antibodies, Fab, Fv or scFv fragments, can be prepared which have retained their binding properties. Such antibodies or fragments can be produced through recombinant DNA technology by microbial fermentation. Well known production hosts for antibodies and their fragments are yeast, moulds or bacteria.

A class of antibodies of particular interest is formed by the Heavy Chain antibodies as found in Camelidae, like the camel or the llama. The binding domains of these antibodies consist of a single polypeptide fragment, namely the variable region of the heavy chain polypeptide (HC-V). In contrast, in the classic antibodies (murine, human, etc.), the binding domain consist of two polypeptide chains (the variable regions of the heavy chain (Vₕ) and the light chain (V₁)). Procedures to obtain heavy chain immunoglobulins from Camelidae, or (functionalized) fragments thereof, have been described in WO-A-94/04678 (Casterman and Hamers) and WO-A-94/25591 (Unilever and Free University of Brussels).

Alternatively, binding domains can be obtained from the Vₕ fragments of classical antibodies by a procedure termed “camelization”. Hereby the classical Vₕ fragment is transformed, by substitution of a number of amino acids, into a HC-V-like fragment, whereby its binding properties are retained. This procedure has been described by Riechmann et al. in a number of publications (J. Mol. Biol. (1996) 259, 957-969; Protein. Eng. (1996) 9, 531-537, Bio/Technology (1995) 13, 475-479). Multivalent antigen-binding proteins based on antibody fragments are also disclosed in WO-A-99/23221 (Unilever). Also HC-V fragments can be produced through recombinant DNA technology in a number of microbial hosts (bacterial, yeast, mould), as described in WO-A-94/29457 (Unilever).

Methods for producing fusion proteins that comprise an enzyme and an antibody or that comprise an enzyme and an antibody fragment are already known in the art. One approach is described by Neuberger and Rabbits (EP-A-194 276). A method for producing a fusion protein comprising an enzyme and an antibody fragment that was derived from an antibody originating in Camelidae is described in WO-A-94/25591. A method for producing bispecific antibody fragments is described by Holliger et al. (1993) PNAS 90, 6444-6448.

A particularly attractive feature of antibody binding behaviour is their reported ability to bind to a “family” of structurally-related molecules. For example, in Gani et al. (J. Steroid Biochem. Molec. Biol. 48, 277-282) an antibody is described that was raised against progesterone but also binds to the structurally-related steroids, pregnanedione, pregnanolone and 6-hydroxy-progesterone. Therefore, using the same approach, antibodies could be isolated that bind to a whole “family” of stain chromophores (such as the polyphenols, porphyrins, or caretenoids as described below). A broad action antibody such as this could be used to treat several different stains when coupled to a bleaching enzyme.

1.2.2. Peptides.

Peptides usually have lower binding affinities to the substances of interest than antibodies. Nevertheless, the binding properties of carefully selected or designed peptides can be sufficient to deliver the desired selectivity in a oxidation process. A peptide which is capable of binding selectively to a substance which one would like to oxidise, can for instance be obtained from a protein which is known to bind to that specific substance. An example of such a peptide would be a binding region extracted from an antibody raised against that substance. Other examples are proline-rich peptides that are known to bind to the polyphenols in wine.

Alternatively, peptides which bind to such substance can be obtained by the use of peptide combinatorial libraries. Such a library may contain up to 10¹⁰ peptides, from which the peptide with the desired binding properties can be isolated. (R. A. Houghten, Trends in Genetics, Vol 9, no &, 235-239). Several embodiments have been described for this procedure (J. Scott et al., Science (1990) 249, 386-390; Fodor et al., Science (1991) 251, 767-773; K. Lam et al., Nature (1991) 354, 82-84; R. A. Houghten et al., Nature (1991) 354, 84-86).

Suitable peptides can be produced by organic synthesis, using for example the Merrifield procedure (Merrifield (1963) J.Am.Chem.Soc. 85, 2149-2154). Alternatively, the peptides can be produced by recombinant DNA technology in microbial hosts (yeast, moulds, bacteria)(K. N. Faber et al. (1996) Appl. Microbiol. Biotechnol. 45, 72-79).

1.2.3. Pepidomimics.

In order to improve the stability and/or binding properties of a peptide, the molecule can be modified by the incorporation of non-natural amino acids and/or non-natural chemical linkages between the amino acids. Such molecules are called peptidomimics (H. U. Saragovi et al. (1991) Bio/Technology 10, 773-778; S. Chen et al. (1992) Proc.Natl.Acad. Sci. USA 89, 5872-5876). The production of such compounds is restricted to chemical synthesis.

1.2.4. Other Organic Molecules.

It can be readily envisaged that other molecular structures, which need not be related to proteins, peptides or derivatives thereof, can be found which bind selectively to substances one would like to oxidise with the desired binding properties. For example, certain polymeric RNA molecules which have been shown to bind small synthetic dye molecules (A. Ellington et al. (1990) Nature 346, 818-822). Such binding compounds can be obtained by the combinatorial approach, as described for peptides (L. B. McGown et al. (1995), Analytical Chemistry, 663A-668A).

This approach can also be applied for purely organic compounds which are not polymeric. Combinatorial procedures for synthesis and selection for the desired binding properties have been described for such compounds (Weber et al. (1995) Angew.Chem.Int.Ed.Engl. 34, 2280-2282; G. Lowe (1995), Chemical Society Reviews 24, 309-317; L. A. Thompson et al. (1996) Chem. Rev. 96, 550-600). Once suitable binding compounds have been identified, they can be produced on a larger scale by means of organic synthesis.

1.3 The Stains

For detergents applications, several classes of coloured substances one would like to bleach can be envisaged, in particular coloured substances which may occur as stains on fabrics can be a target. However, it is also important to emphasise that many stains are heterogeneous. Therefore, the substance to be targeted need not itself be coloured providing that it is always present in the mixture of substances that constitute a stain.

Moreover, an important embodiment of the invention is to use a binding compound (refer to 1.2) that binds to several different, but structurally-related, molecules in a class of “stain substances”. This would have the advantage of enabling a single enzyme species to bind (and bleach) several different stains. An example would be to use an antibody which binds to the polyphenols in wine, tea, and blackberry. Further examples of classes of stain substances are given below:

1.3.1. Porphyrin Derived Structures.

Porphyrin structures, often coordinated to a metal, form one class of coloured substances which occur in stains. Examples are heme or haematin in blood stain, chlorophyll as the green substance in plants, e.g. grass or spinach. Another example of a metal-free substance is bilirubin, a yellow breakdown product of heme.

1.3.2. Tannins, Polyphenols

Tannins are polymerised forms of certain classes of polyphenols. Such polyphenols are catechins, leuantocyanins, etc. (P. Ribéreau-Gayon, Plant Phenolics, Ed. Oliver & Boyd, Edinburgh, 1972, pp.169-198). These substances can be conjugated with simple phenols like e.g. gallic acids. These polyphenolic substances occur in tea stains, wine stains, banana stains, peach stains, etc. and are notoriously difficult to remove.

1.3.3. Carotenoids.

(G. E. Bartley et al. (1995), The Plant Cell 7, 1027-1038). Carotenoids are the coloured substances which occur in tomato (lycopene, red), mango (β-carotene, orange-yellow). They occur in food stains (tomato) which are also notoriously difficult to remove, especially on coloured fabrics, when the use of chemical bleaching agents is not advised.

1.3.4. Anthocyanins.

(P. Ribéreau-Gayon, Plant Phenolics, Ed. Oliver & Boyd, Edinburgh, 1972, 135-169). These substance are the highly coloured molecules which occur in many fruits and flowers. Typical examples, relevant for stains, are berries, but also wine. Anthocyanins have a high diversity in glycosidation patterns.

1.3.5. Maillard Reaction Products

Upon heating of mixtures of carbohydrate molecules in the presence of protein/peptide structures, a typical yellow/brown coloured substance arises. These substances occur for example in cooking oil and are difficult to remove from fabrics.

2. The Detergent Composition.

The bleaching enzymes can be used in a detergent composition, specifically suited for stain bleaching purposes, and this constitutes a second aspect of the invention. To that extent, the composition comprises a surfactant and optionally other conventional detergent ingredients. The invention in its second aspect provides an enzymatic detergent composition which comprises from 0.1-50% by weight, based on the total detergent composition, of one or more surfactants. This surfactant system may in turn comprise 0-95% by weight of one or more anionic surfactants and 5-100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside- Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system which is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

The detergent composition may take any suitable physical form, such as a powder, an aqueous or non aqueous liquid, a paste or a gel.

The bleaching enzyme used in the present invention can usefully be added to the detergent composition in any suitable form, i.e. the form of a granular composition, a liquid or a slurry of the enzyme, or with carrier material (e.g. as in EP-A-258 068 and the Savinase (TM) and Lipolase (TM) products of Novo Nordisk). A good way of adding the enzyme to a liquid detergent product is in the form of a slurry containing 0.5 to 50% by weight of the enzyme in a ethoxylated alcohol nonionic surfactant, such as described in EP-A-450 702 (Unilever).

The enzymatic bleaching compositions of the invention comprise about 0.001 to 10 milligrams of active bleaching enzyme per liter. A detergent composition will comprise about 0.001% to 1% of active enzyme (w/w).

The enzyme activity can be expressed in units. For example, in the case of glucose oxidase, one unit will oxidise 1 μmole of β-D-glucose to D-gluconolactone and H₂O₂ per minute at pH 6.5 at 30°C. The enzyme activity which is added to the enzymatic bleaching composition will be about 2.0 to 4,000 units per litre (of wash liquor).

The invention will now be further illustrated in the following, non-limiting Examples.

### EXAMPLE 1

Binding of Bihead (pI 9) to Unstained Fabric.

A Bihead was constructed (anti Glucose Oxidase—anti polyphenols/Red wine (Côtes du Rhône wine (Co-op, U.K.)) according to the method described in WO-A-99/23221 (Unilever).

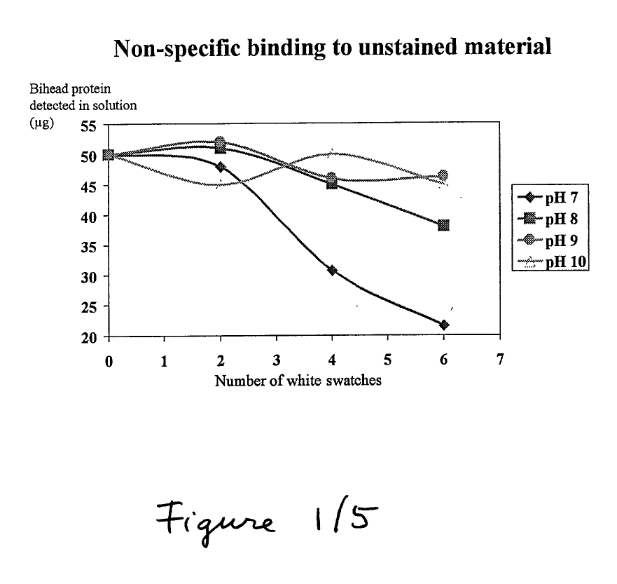

The concentration of anti GOX-anti Red Wine bihead unbound in a cotton cloth containing solution was determined by a micro-BCA protein method. The number of white cotton fabric pieces influenced the amount of bihead absorbing to the fabric. FIG. 1 shows the bihead binding to the cotton at pH 7 and 8, as indicated by a drop in the amount of bihead detected in the solution. In contrast, the amount of bihead in the solution at pH9 and 10 did not decrease as the number of white swatches increased, thus indicative of the absence of non-specific binding to the cotton at this higher pH.

### EXAMPLE 2

Binding of other Biheads to Unstained Fabric

Example 1 was repeated, using variants of the (anti Glucose Oxidase—anti polyphenols/Red wine) Bihead, having different pI values. White, unstained cloth, 2×2cm was used that had been prewashed for 10 minutes in MQ H₂O. 0, 1, 2 and 5 swatches placed in 10 ml of each of the various buffers, in duplicate plus 100μg of bihead. Control set consisted of 0, 1, 2 and 5 swatches in 10 ml of each of the various buffers but without bihead. Mixed on a rotary mixer for 15 minutes at room temperature and then left to stand for 10 minutes. After which, aliquot taken from each and immediately assayed using micro BCA protein assay. The following Biheads were used:

12/49, having a pI of 9.5

12/49 myc tail, having a pI of 8.8

12/11, having a pI of 8.0.

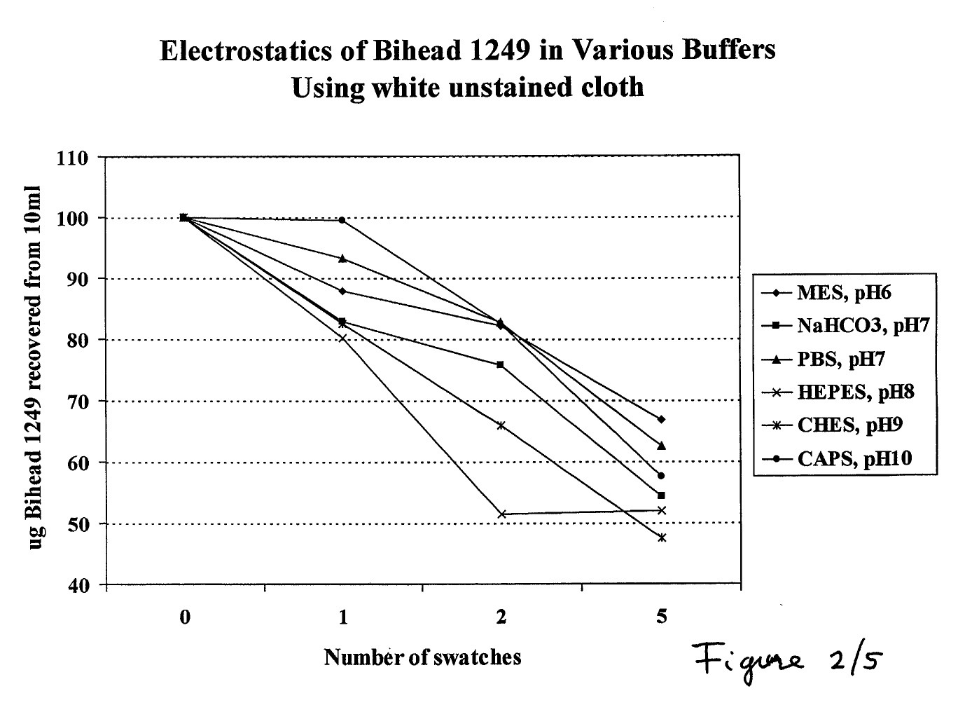

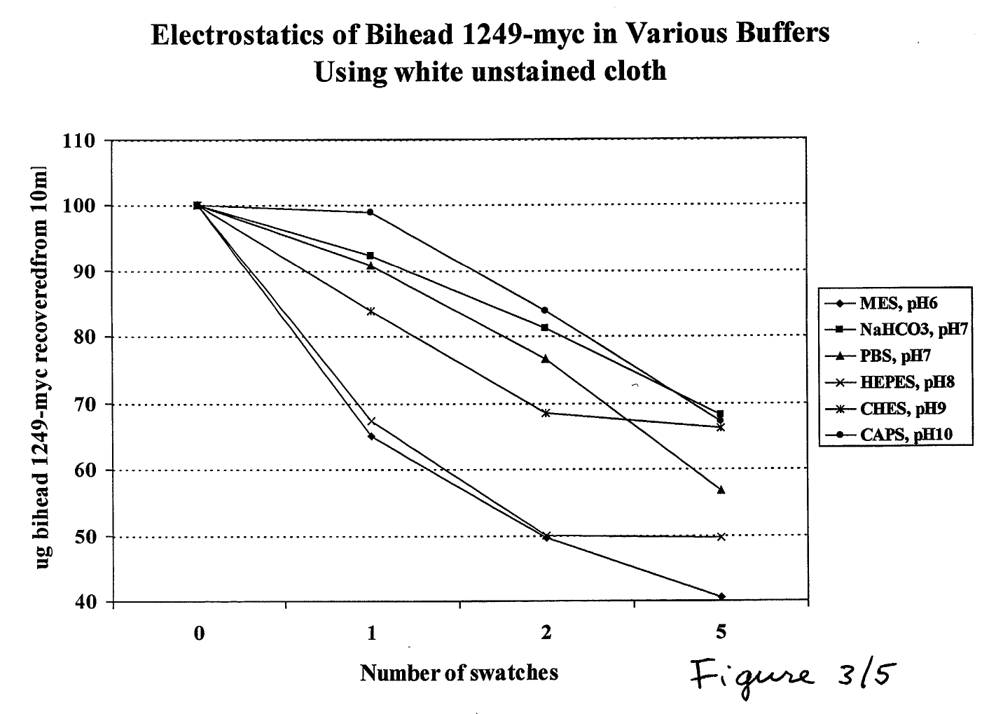

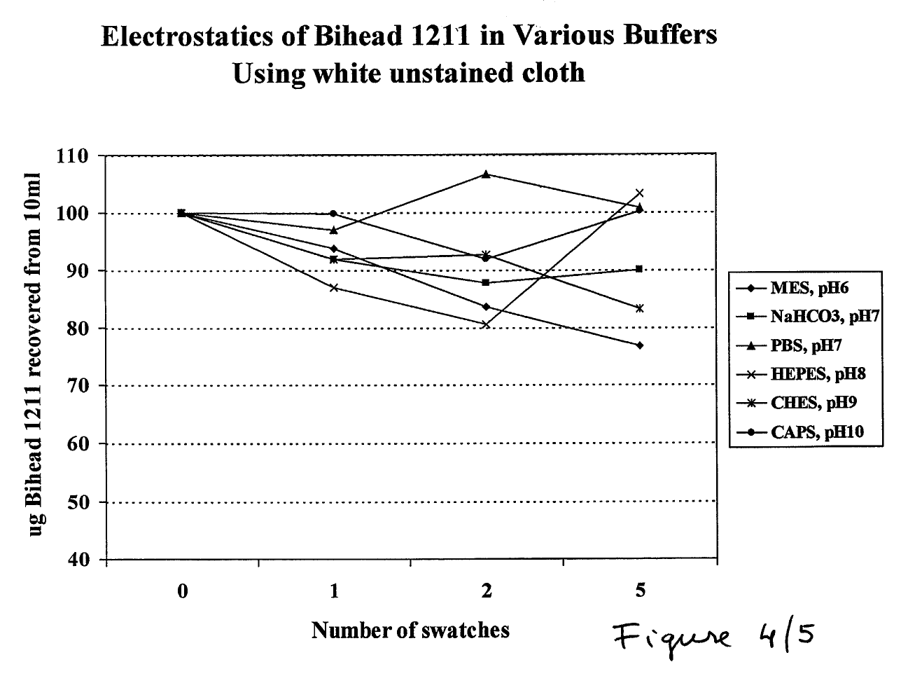

The results are shown in FIGS. 2, 3 and 4. These graphs show the non-specific binding to cotton as a function of pH. The pI values are deduced pI values. The benefit of using a bihead with a pI that falls outside the liquor pH window for reduced or no non-specific binding to unstained ballast cloth is evident.

### EXAMPLE 3

Bleaching Performance of Targeted Enzyme.

The performance of the glucose oxidase, targeted or non-targeted, was compared in a detergent composition (OMO) at pH values above and below the pI of the biheaded antibody. The following detergent composition was used (amounts in % by weight):

| | |
|---|---|
| LAS | 24 |
| STP | 14.5 |
| Sodium Methyl Cellulose | 0.37 |
| Sodium Sulphate | 25.5 |
| Sodium Carbonate | 17.5 |
| Sodium Silicate | 6.9 |
| Moisture | 6.2 |
| Minors | 5.0 |

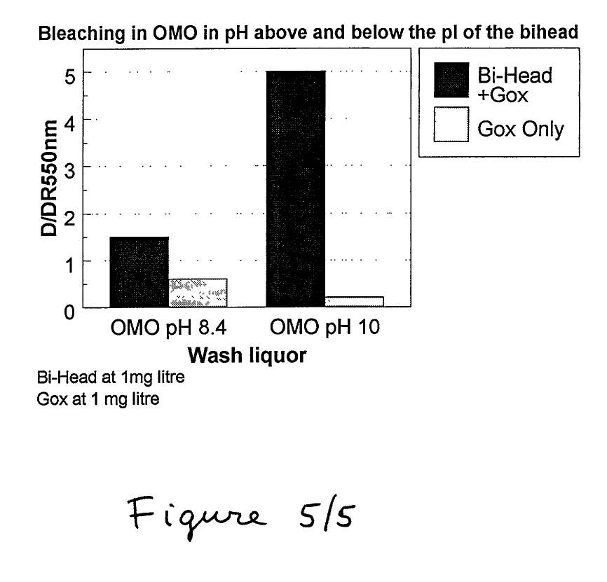

The results are show in FIG. 5. The results clearly show that the benefits of targeted bleaching are only apparent in pH solutions above the pI of the antibody molecule. The reaction systems contained an equal ratio of stained and white unstained material. Hence, when the pH was above the pI, only specific antibody binding occurred to its target present on the stained fabric, whereas below the pI, the antibody could bind both specifically to its target and non-specifically to unstained fabric. Therefore, the effect of the targeted bleaching enzyme Glucose Oxidase (Gox) is enhanced at the higher pH.

1. Enzymatic bleaching detergent composition comprising a bleaching enzyme capable of generating a bleaching chemical and having a high binding affinity for stains present on fabrics, said enzyme comprising an enzyme part capable of generating a bleaching chemical which is coupled to a reagent having a high binding affinity for stains present on fabrics, characterised in thatthe pI of the reagent having the high binding affinity has a pI which is lower than the pH of an aqueous wash solution comprising 1 g/l of the composition.

2. Enzymatic bleaching detergent composition according to claim 1, wherein the pI is 0.1-5, preferably 0.1-2 units lower than the pH, more preferably 0.2-0.5 units lower than the pH.

3. Enzymatic bleaching detergent composition according to claim 1, wherein the enzyme part is an oxidase and the bleaching chemical is hydrogen peroxide.

4. Enzymatic bleaching detergent composition according to claim 1, wherein the enzyme part is an oxidase selected from the group consisting of glucose oxidase, galactose oxidase and alcohol oxidase.

5. Enzymatic bleaching detergent composition according to claim 1, wherein the enzyme part is a haloperoxidase and the bleaching chemical is hypohalite.

6. Enzymatic bleaching detergent composition according to claim 1, wherein the enzyme part is a chloroperoxidase and the bleaching chemical is hypochlorite.

7. Enzymatic bleaching detergent composition according to claim 1, wherein the enzyme part is a Vanadium chloroperoxidase.

8. Enzymatic bleaching detergent composition according to claim 1, wherein the enzyme part is a Curvularia inaequalis Vanadium chloroperoxidase.

9. Enzymatic bleaching detergent composition according to claim 1, where the enzyme part is a laccase or a peroxidase and the bleaching molecule is derived from an enhancer molecule that has reacted with the enzyme.

10. Enzymatic bleaching detergent composition according to claim 1, wherein the enzyme part is coupled to a reagent having a high binding affinity for porphyrin derived structures, tannins, polyphenols, carotenoids, anthocyanins, maillard reaction products.

11. Enzymatic bleaching detergent composition according to claim 1, wherein the enzyme part is coupled to a reagent having a high binding affinity for porphyrin derived structures, tannins, polyphenols, carotenoids, anthocyanins, or maillard reaction products when they are adsorbed onto a surface.

12. Enzymatic bleaching detergent composition according to claim 1, wherein the surface is cotton, polyester, or polyester/cotton fabric.

13. Enzymatic bleaching detergent composition according to claim 1, wherein the reagent having a high binding affinity is an antibody, an antibody fragment, or a derivative thereof.

14. Enzymatic bleaching detergent composition according to claim 1, wherein the reagent having a high binding affinity is a fusion protein comprising a bleaching enzyme and all or part of a heavy chain immunoglobulin that was raised in Camelidae and has a specificity for stain molecules.

15. Enzymatic bleaching detergent composition according to claim 1, comprising a multi-specific antibody or antibody or an analogous structure arranged so that at least one specificity is directed to stains present on fabrics and the others are directed to one or more bleaching enzymes.

16. Enzymatic bleaching detergent composition according to claim 1, wherein the reagent having a high binding affinity has a chemical equilibrium constant Kd for the substance of less than 10⁻⁴ M, preferably less than 10⁻⁶ M.

17. Enzymatic bleaching detergent composition according to claim 1, wherein the reagent having a high binding affinity has a chemical equilibrium constant K_{d} of less than 10⁻⁷ M.

18. Enzymatic bleaching detergent composition according to claim 1, comprising a bispecific antibody or antibody fragment or a diabody or an analogous structure arranged so that one specificity is directed to stains present on fabrics and the other is directed to a bleaching enzyme.

19. Enzymatic bleaching detergent composition according to claim 1, comprising an antibody or antibody fragment or derivative thereof that binds to chemical constituents that are present in tea, blackberry and red wine.

20. Enzymatic bleaching detergent composition according to claim 1, comprising one or more surfactants, a bleaching enzyme producing hydrogen peroxide and a bleach activator which generates peracetic acid.

21. Enzymatic bleaching detergent composition according to claim 1, comprising one or more surfactants, a bleaching enzyme producing hydrogen peroxide and a transition metal catalyst.

22. Process for bleaching stains present on fabrics, wherein stained fabrics are contacted with a solution comprising the composition according to claim 1.
